(19) United States
(12) Patent Application Publication
(10) Pub. No.: US 2026/0213090 A1
(43) Pub. Date: Jul. 23, 2026

(54) KEY DEVICE

(71) Applicant: SUNREX TECHNOLOGY CORP, Taichung City (TW)

(72) Inventors: Bao-Song MA, Chongqing City (CN); Yin CHU, Chongqing City (CN); Shih-Pin LIN, Taichung City (TW)

(21) Appl. No.: 19/183,180

(22) Filed: Apr. 18, 2025

(30) Foreign Application Priority Data
Jan. 23, 2025 (TW) 114201001

(51) Int. Cl. H01H 13/14

(52) U.S. Cl. CPC H01H 13/14

(57) ABSTRACT

A key device includes a base plate, a connection module, a membrane circuit board, an elastic body, a support module, and a keycap. The base plate has a travel space. The connection module and the membrane circuit board are disposed on the base plate. The elastic body is disposed on the membrane circuit board. A projection of the elastic body on an imaginary plane is located within a projection of a periphery of the travel space on the imaginary plane. The support module is connected to the connection module. The keycap is disposed on the support module. When the keycap is pressed, the elastic body and the membrane circuit board are deformed such that a portion of the elastic body underneath the keycap and a portion of the membrane circuit board underneath the elastic body are thrust into the travel space.

### CROSS-REFERENCE TO RELATED APPLICATION

This application claims priority to Taiwanese Utility Model Patent Application No. 114201001, filed on January 23, 2025, the entire disclosure of which is incorporated by reference herein.

### FIELD

The disclosure relates to an input device, and more particularly to a key device which has an increased travel distance.

### BACKGROUND

An existing key device is adapted for a membrane keyboard of a notebook computer. The existing key device includes a base plate, a membrane circuit board disposed above the base plate, a rubber member disposed above the membrane circuit, a scissor module disposed above the base plate, and a keycap disposed above the scissor module and the rubber member. When the keycap is pressed, the rubber member is compressed against the membrane circuit so as to generate an electrical signal.

Because the notebook computer becomes increasingly thinner and lighter in design, there is room for improvement to increase a travel distance of the key device while maintaining a dimension of the key device.

### SUMMARY

Therefore, an object of the disclosure is to provide a key device that can alleviate at least one of the drawbacks of the prior art.

According to the disclosure, a key device includes a base unit, a membrane circuit board, an elastic body, a support module, and a keycap.

The base unit includes a base plate and a connection module. The base plate has a top surface and a travel space extending downwardly from the top surface in a top-bottom direction. The connection module is disposed on the base plate.

The membrane circuit board is disposed on the top surface.

The elastic body is disposed on a top side of the membrane circuit board. A projection of the elastic body in the top-bottom direction on an imaginary plane is located within a projection of a periphery of the travel space in the top-bottom direction on the imaginary plane.

The support module is connected to the connection module.

The keycap is disposed on the support module.

When the keycap is pressed, the elastic body and the membrane circuit board are deformed such that a portion of the elastic body underneath the keycap and a portion of the membrane circuit board underneath the elastic body are thrust downwardly into the travel space.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a key device according to an embodiment of the disclosure.

FIG. 2 is an exploded perspective view of the embodiment illustrating the key device.

FIG. 3 is a top view of the embodiment illustrating a base unit, a membrane circuit, and an elastic body of the key device.

FIG. 4 is a sectional view taken along line IV-IV of FIG. 3.

FIG. 5 is a sectional view taken along line V-V of FIG. 3.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

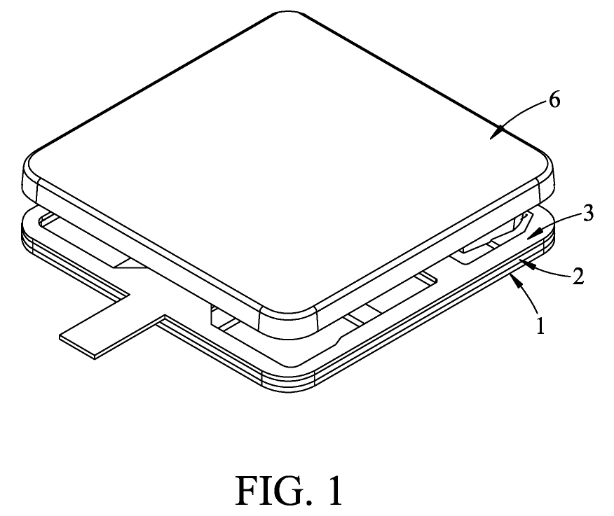

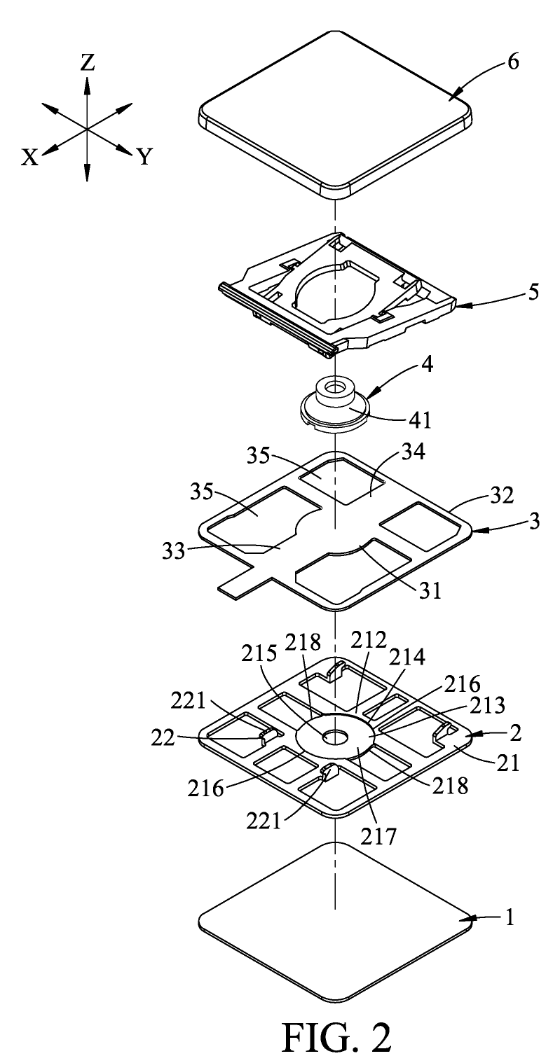

Referring to FIGS. 1 and 2, a key device according to an embodiment of the disclosure is illustrated. The key device of the disclosure includes a backlit module 1, a base unit 2, a membrane circuit board 3, an elastic body 4, a support module 5, and a keycap 6.

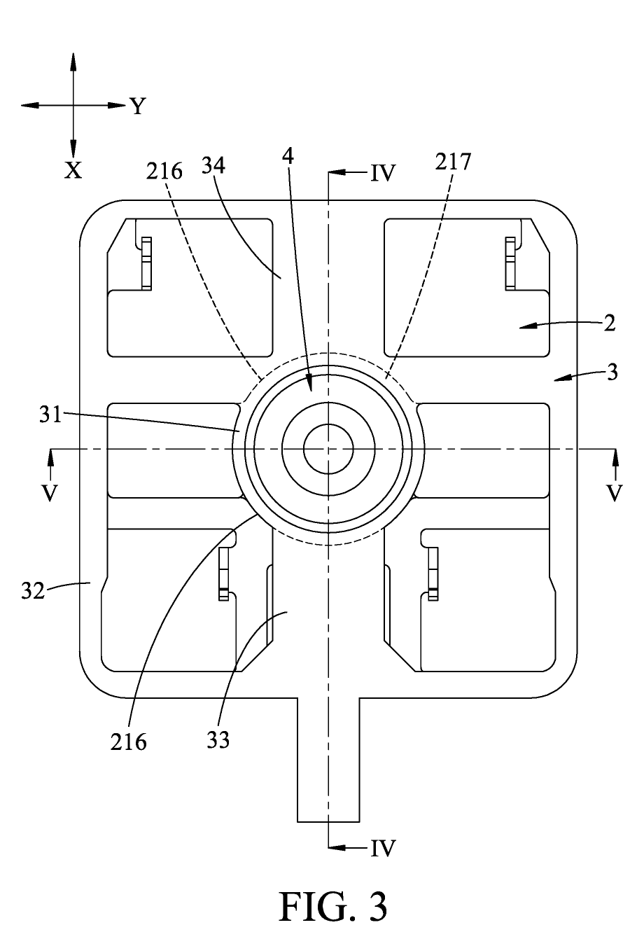

Referring to FIGS. 2 to 4, the backlit module 1, the base unit 2, and the membrane circuit board 3 are stacked on and adhered to each other in a top-bottom direction (Z). The backlit module 1 is disposed below the base unit 2. The base unit 2 includes a base plate 21 that is adhered to the backlit module 1, and a connection module 22 that is disposed on the base plate 21. The connection module 22 has a plurality of hooks 221 disposed on the case plate 21.

The base plate 21 has a top surface 212, a recession surface 213, a riser surface 214, and a bottom surface 211. The recession surface 213 is disposed below the top surface 212 in the top-bottom direction (Z). The riser surface 214 interconnects the top surface 212 and the recession surface 213. The bottom surface 211 is disposed below the recession surface 213 in the top-bottom direction (Z).

The recession surface 213 is located in the middle of the base plate 21. In this embodiment, the base plate 21 further has a through hole 215 that extends from the recession surface 213 to the bottom surface 211.

The riser surface 214 has two riser surface sections 216 that are opposite to each other in a first direction (X) perpendicular to the top-bottom direction (Z) and that are respectively connected to opposite ends of the recession surface 213. Each of the riser surface sections 216 extends from a periphery of the recession surface 213 and is curved. The riser surface 214 and the recession surface 213 cooperatively define a travel space 217 that extends downwardly from the top surface 212 in a top-bottom direction (Z) and that is cylindrical. The through hole 215 is in communication with the travel space 217. The travel space 217 has two openings 218 that are opposite to each other in a second direction (Y) perpendicular to the top-bottom direction (Z) and the first direction (X), that are respectively located at opposite ends of the recession surface 213, and that are formed between the riser surface sections 216.

A thickness (h) of the base plate 21 in the top-bottom direction (Z) between the top surface 212 and the bottom surface 211 is larger than a depth (d) of the travel space 217 in the top-bottom direction (Z) between the top surface 212 and the recession surface 213. Specifically, the thickness (h) of the base plate 21 is 0.3 mm. The depth (d) of the travel space 217 ranges from 0.1 mm to 0.15 mm. A diameter (D1) of the travel space 217 is 6.4 mm. In some embodiments, the base plate 21 may be dispensed with the recession surface 213 and the through hole 215, and the travel space 217 may be a penetrating hole that extends through the top surface 212 and the bottom surface 211 (Z).

The membrane circuit board 3 is disposed on the top surface 212, and has an abutment portion 31, a surrounding portion 32, a first connection portion 33, and a second connection portion 34. The abutment portion 31 is disposed above the travel space 217 in the top-bottom direction (Z). The surrounding portion 32 surrounds the abutment portion 31. The first connection portion 33 and the second connection portion 34 interconnect the abutment portion 31 and the surrounding portion 32 in the first direction (X), and are disposed respectively at opposite sides of the abutment portion 31 in the first direction (X). The surrounding portion 32, the first connection portion 33, and the second connection portion 34 abut against and are adhered to the top surface 212 of the base plate 21. The abutment portion 31, the surrounding portion 32, the first connection portion 33, and the second connection portion 34 cooperatively define a plurality of through openings 35 through which the hooks 221 of the connection module 22 pass. The abutment portion 31 has a connecting end that is connected to the first connection portion 33. A contour of a projection of the connecting end of the abutment portion 31 in the top-bottom direction (Z) on an imaginary plane (P) overlaps a contour of a periphery of the travel space 217 in the top-bottom direction (Z) on the imaginary plane (P). Specifically, the contour of the projection of the connecting end of the abutment portion 31 in the top-bottom direction (Z) on the imaginary plane (P) overlaps a contour of a projection of a corresponding one of the riser surface sections 216 in the top-bottom direction (Z) on the imaginary plane (P), and the corresponding riser surface 216 is adjacent to the first connection portion 33.

The elastic body 4 is disposed on a top side of the membrane circuit board 3. A projection of the elastic body 4 in the top-bottom direction (Z) on the imaginary plane (P) is located within the projection of the periphery of the travel space 217 in the top-bottom direction (Z) on the imaginary plane (P). The abutment portion 31 of the membrane circuit board 3 is disposed under the elastic body 4 and above the travel space 217 in the top-bottom direction (Z). In this embodiment, the elastic body 4 has a hollow cover portion 41 and a protrusion 42. The hollow cover portion 41 is disposed between the membrane circuit board 3 and the keycap 6. The protrusion 42 extends downwardly from an inner side of the cover portion 41 and is aligned with the through hole 215 in the top-bottom direction (Z). A bottom end of the cover portion 41 is circular and has a diameter (D2) of 5.4 mm, which is smaller than the diameter (D1) of the travel space 217. As a result, a projection of the bottom end of the cover portion 41 in the top-bottom direction (Z) on the imaginary plane (P) is located within the projection of the periphery of the travel space 217 in the top-bottom direction (Z) on the imaginary plane (P).

The support module 5 is a scissor module and is connected to the hooks 221. The keycap 6 is disposed on and engaged with the support module 5, and is located above the elastic body 4.

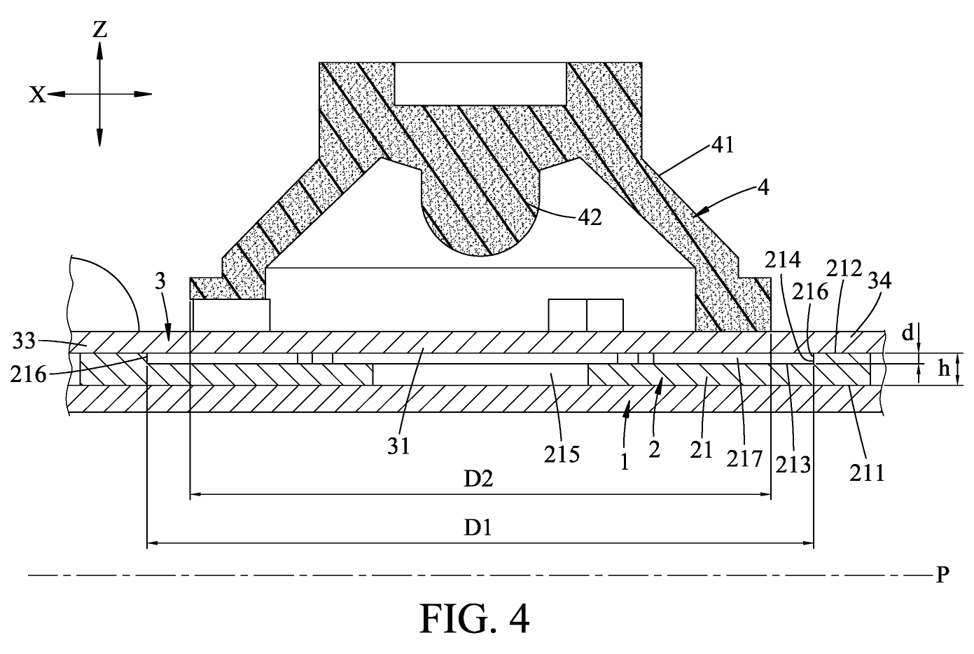

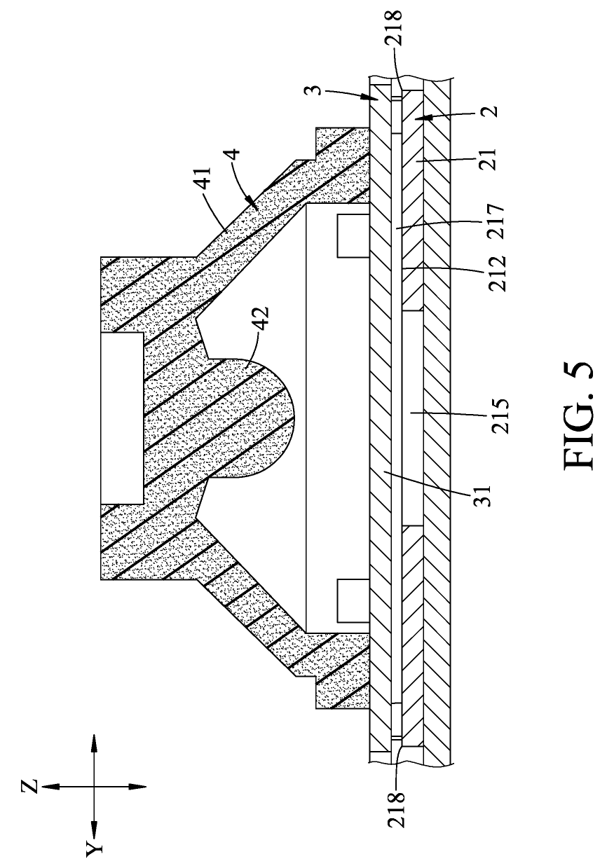

Referring to FIGS. 4 and 5 in combination with FIG. 1, when the keycap 6 is pressed, the elastic body 4 and the membrane circuit board 3 are deformed such that a portion of the elastic body 4 underneath the keycap 6 and a portion of the membrane circuit board 3 underneath the elastic body 4 are thrust downwardly into the travel space 217. Because the contour of the projection of the connecting end of the abutment portion 31 of the membrane circuit board 3 in the top-bottom direction (Z) on the imaginary plane (P) overlaps the contour of the projection of a corresponding riser surface section 216 in the top-bottom direction (Z) on the imaginary plane (P), and because the openings 218 formed between the riser surface sections 216 allow the membrane circuit board 3 to be more deformed downwardly, the abutment portion 31 is easily thrust to abut against the recession surface 213 such that the bottom end of the cover portion 41 of the elastic body 4 is thrust closer to a bottom side of the travel space 217 in connection with the recession surface 213. As a result, comparing the key device of the disclosure with that of the prior art, when the keycap 6 is pressed downwardly, a travel distance of the key device of the disclosure in the top-bottom direction (Z) is effectively increased by virtue of the depth (d) of the travel space 217 in the top-bottom direction (Z), i.e., the travel distance of the key device of the disclosure is increased to range from 0.1 mm to 0.15 mm. In addition, an abutment of the protrusion 42 of the elastic body 4 against the abutment portion 31 of the membrane circuit board 3 may drive the protrusion 42 and the abutment portion 31 to move downwardly together into the through hole 215 of the base plate 21, so that the elastic body 4 may move downwardly without hindrance.

In summary, because the base plate 21 has the travel space 217, and because the projection of the elastic body 4 in the top-bottom direction (Z) on the imaginary plane (P) is located within the projection of the periphery of the travel space 217 in the top-bottom direction (Z) on the imaginary plane (P), when the keycap 6 is pressed, the elastic body 4 and the membrane circuit board 3 are deformed to be thrust together downwardly into the travel space 217. By virtue of the travel space 217, the travel distance of the key device of the disclosure is increased so as to enhance key pressing feedback.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A key device comprising:
a base unit including
a base plate that has a top surface and a travel space extending downwardly from said top surface in a top-bottom direction, and
a connection module that is disposed on said base plate;
a membrane circuit board disposed on said top surface;
an elastic body disposed on a top side of said membrane circuit board, a projection of said elastic body in the top-bottom direction on an imaginary plane being located within a projection of a periphery of said travel space in the top-bottom direction on the imaginary plane;
a support module connected to said connection module; and
a keycap disposed on said support module;
wherein, when said keycap is pressed, said elastic body and said membrane circuit board are deformed such that a portion of said elastic body underneath said keycap and a portion of said membrane circuit board underneath said elastic body are thrust downwardly into said travel space.

2. The key device as claimed in claim 1, wherein said base plate further has
a recession surface that is disposed below said top surface in the top-bottom direction, and
a riser surface that interconnects said top surface and said recession surface, said riser surface and said recession surface cooperatively defining said travel space.

3. The key device as claimed in claim 2, wherein:
said riser surface has two riser surface sections that are opposite to each other in a first direction perpendicular to the top-bottom direction and that are respectively connected to opposite ends of said recession surface; and
said travel space has two openings that are opposite to each other in a second direction perpendicular to the top-bottom direction and the first direction, that are respectively located at opposite ends of said recession surface, and that are formed between said riser surface sections.

4. The key device as claimed in claim 3, wherein each of said riser surface sections extends from a periphery of said recession surface and is curved.

5. The key device as claimed in claim 2, wherein:
said base plate further has a bottom surface that is disposed below said recession surface in the top-bottom direction; and
a thickness of said base plate in the top-bottom direction between said top surface and said bottom surface is larger than a depth of said travel space in the top-bottom direction between said top surface and said recession surface.

6. The key device as claimed in claim 2, wherein:
said base plate further has
a bottom surface that is disposed below said recession surface in the top-bottom direction, and
a through hole that extends from said recession surface to said bottom surface and that is in communication with said travel space; and
said elastic body has
a hollow cover portion that is disposed between said membrane circuit board and said keycap, and
a protrusion that extends downwardly from an inner side of said cover portion and that is aligned with said through hole in the top-bottom direction.

7. The key device as claimed in claim 1, wherein:
said membrane circuit board has
an abutment portion that is disposed under said elastic body in the top-bottom direction,
a surrounding portion that surrounds said abutment portion, and
a first connection portion and a second connection portion that interconnect said abutment portion and said surrounding portion, and that are disposed respectively at opposite sides of said abutment portion; and
said surrounding portion, said first connection portion, and said second connection portion abut against said top surface of said base plate.

8. The key device as claimed in claim 7, wherein:
said abutment portion has a connecting end that is connected to said first connection portion; and
a contour of a projection of said connecting end of said abutment portion in the top-bottom direction on the imaginary plane overlaps a contour of said periphery of said travel space in the top-bottom direction on the imaginary plane.

9. The key device as claimed in claim 1, wherein:
said connection module has a plurality of hooks; and
said support module is a scissor module connected to said hooks.

10. The key device as claimed in claim 1, further comprising a backlit module that is disposed below said base unit.
